(19) United States
(12) Patent Application Publication
(10) Pub. No.: US 2026/0159315 A1
(43) Pub. Date: Jun. 11, 2026

(54) REFUSE VEHICLE WITH CONTAMINANT SEPARATION AND ON-VEHICLE STORAGE

(71) Applicant: Oshkosh Corporation, Oshkosh, WI (US)

(72) Inventors: Jerrod Kappers, Oshkosh, WI (US); Vince Andrada, Oshkosh, WI (US); Joel Komurka, Oshkosh, WI (US); Joseph Wigle, Oshkosh, WI (US); Vince Schad, Oshkosh, WI (US); Brian Brost, Oshkosh, WI (US)

(73) Assignee: Oshkosh Corporation, Oshkosh, WI (US)

(21) Appl. No.: 19/414,091

(22) Filed: Dec. 9, 2025

Related U.S. Application Data
(60) Provisional application No. 63/730,243, filed on Dec. 10, 2024.

(51) Int. Cl. B65F 3/14

(52) U.S. Cl. CPC B65F 3/143; B65F 2003/146

(57) ABSTRACT

A refuse vehicle may include a body defining a pair of refuse compartments including an isolation compartment and a storage compartment. The refuse vehicle may include a conveyor configured to direct refuse material into one of the pair of refuse compartments. The refuse vehicle may include an actuator configured to selectively redirect the refuse material from the conveyor to the isolation compartment. The refuse vehicle may include one or more sensors. The refuse vehicle may include processing circuitry configured to operate the actuator in a first direction to direct the refuse material to the storage compartment, determine, based on the sensor data, a presence of an object on the conveyor that should be directed to the isolation compartment, and operate the actuator in a second direction to redirect the object from the conveyor to the isolation compartment.

### CROSS-REFERENCE TO RELATED PATENT APPLICATIONS

This application claims the benefit and priority to U.S. Provisional Application No. 63/730,243, filed on Dec. 10, 2024, the entire contents of which are hereby incorporated by reference herein.

### BACKGROUND

The present disclosure generally relates to the field of refuse vehicles and systems for analyzing refuse materials received by the refuse vehicle.

### SUMMARY

One embodiment relates to a refuse vehicle including a body defining a pair of refuse compartments including an isolation compartment and a storage compartment, a conveyor configured to direct refuse material received into the body into one of the pair of refuse compartments, an actuator configured to selectively redirect the refuse material from the conveyor to the isolation compartment, one or more sensors configured to collect sensor data regarding the refuse material, and processing circuitry. The processing circuitry may operate the actuator in a first direction to direct the refuse material to the storage compartment, determine, based on the sensor data, a presence of an object on the conveyor that should be directed to the isolation compartment, and operate the actuator in a second direction to redirect the object from the conveyor to the isolation compartment.

Another embodiment relates to a refuse vehicle including a body defining a pair of refuse compartments including a storage compartment and an isolated compartment, a hopper configured to receive refuse and direct the refuse into one of the pair of refuse compartments, a robotic arm configured to arrange refuse within the hopper, and processing circuitry. The processing circuitry may receive an indication that an object of refuse being deposited into the hopper should be separated from other refuse, and operate the robotic arm to place the object in a predetermined section of the hopper, the predetermined section configured to direct the object for storage in the isolated compartment.

Another embodiment relates to a refuse vehicle including a body defining a pair of refuse compartments including a storage compartment and an isolated compartment, a hopper configured to receive refuse including a partition separating the hopper into a first hopper portion and a second hopper portion, an actuator coupled to the partition configured to pivot the partition between a first position and a second position, and processing circuitry. The processing circuitry may receive an indication that an object being deposited in the hopper should be directed to the isolated compartment; and operate the actuator to pivot the partition from the first position to the second position.

Another embodiment relates to a refuse vehicle. The refuse vehicle includes a body defining a pair of refuse compartments a conveyor configured to direct refuse material received into the body into one of the pair of refuse compartments including an isolation compartment and a storage compartment, an actuator configured to selectively redirect the refuse material from the conveyor to the isolation compartment, and processing circuitry. The processing circuitry is configured to operate the actuator to direct the refuse material to the storage compartment, receive an indication that an object on the conveyor should be separated, and operate the actuator to redirect the object from the conveyor to the isolation compartment, responsive to the indication.

Another embodiment relates to a refuse vehicle. The refuse vehicle includes a body defining a pair of refuse compartments, a hopper configured to receive refuse and direct the refuse into one of the pair of refuse compartments, a robotic arm configured to arrange refuse within the hopper, and processing circuitry. The processing circuitry is configured to receive an indication that an object of refuse being deposited by the robotic arm should be separated from the other refuse and operate the robotic arm to place the refuse in a predetermined section of the hopper. The predetermined section is configured to direct the refuse for storage in one of the pair of refuse compartments separate from other refuse.

Another embodiment relates to a refuse vehicle. The refuse vehicle includes a body defining a refuse compartment, a hopper configured to receive refuse and direct the refuse into the refuse compartments, a user interface, and processing circuitry. The processing circuitry is configured to receive an indication that an object in the hopper should be separated from other refuse, and transmit a message for display on the user interface indicating that the object should be separated from other refuse.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for use with any of the refuse vehicles of FIGS. 1-3, according to an exemplary embodiment;

FIG. 5 is a block diagram of a control system for hopper-based contaminant separation system for a refuse vehicle, according to an exemplary embodiment;

FIG. 6 is a diagram of a hopper-based contaminant separation system for a refuse vehicle, according to an exemplary embodiment;

FIG. 7 is a flow diagram of a method for hopper-based contaminant separation, according to an exemplary embodiment;

FIG. 8 is a diagram of hopper-based contaminant separation using a robotic arm, according to an exemplary embodiment;

FIG. 9 is a flow diagram of a method for hopper-based contaminant separation using a robotic arm, according to an exemplary embodiment;

FIG. 10 is a block diagram of a control system for conveyor-based contaminant separation for a refuse vehicle, according to an exemplary embodiment;

FIG. 11 is a diagram of a bidirectional conveyor system used for contaminant separation, according to an exemplary embodiment;

FIG. 12 is a flow diagram of a method for contaminant separation using a bidirectional conveyor system, according to an exemplary embodiment;

FIG. 13 is diagram of a multi-stage conveyor system used for contaminant separation, according to an exemplary embodiment;

FIG. 14 is a flow diagram of a method for using a multi-stage conveyor system for contaminant separation, according to an exemplary embodiment;

FIG. 15 is a block diagram of a control system for shred-based contaminant neutralization, according to an exemplary embodiment;

FIG. 16 is a diagram of a shred-based contaminant neutralization system, according to an exemplary embodiment;

FIG. 17 is a flow diagram of a method for using a shredding device for contaminant neutralization, according to an exemplary embodiment; and

FIG. 18 is a block diagram of a control system for adjusting the packing profile of a refuse vehicle based on detected contaminants, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Refuse vehicles (e.g., garbage trucks, waste collection trucks, sanitation trucks, etc.) are vehicles configured to collect, process, and transport refuse. Hazardous articles or waste contaminants, such as batteries (e.g., lithium-ion batteries) are often disposed of with other types of refuse materials instead of being handled properly. When these contaminants are inadvertently collected and processed by a refuse vehicle not configured to do so, dangerous conditions can arise. For example, inadvertently compacting a lithium-ion battery intermixed with a quantity of refuse may cause a fire that is difficult to extinguish, and/or can ignite other materials that have been collected by the refuse vehicle, such as during waste compaction, transfer, and/or unloading operations.

Referring generally to the FIGURES, various exemplary embodiments of refuse vehicles that include a contaminant handling system for separating, isolating, and/or neutralizing hazardous and non-hazardous waste contaminants (e.g., batteries, abnormal and/or foreign materials, and/or materials of different types) are shown. The refuse vehicle may include a single refuse compartment or multiple refuse compartments. The containment handling system may be configured to deliver refuse emptied into the hopper to one of the refuse compartments or into the refuse compartment, depending on the configuration of the refuse vehicle (e.g., if the refuse vehicle has a single refuse compartment or multiple refuse compartments). The refuse vehicle can also include cameras or other sensors to obtain scan data (e.g., image data) of the hopper including the refuse material that is deposited into the hopper. The refuse vehicle may include processing circuitry to receive the sensor data and determine the presence of one or more contaminants should be separated from common or regular refuse material.

In some embodiments, the contaminant handling system may separate contaminants from other refuse material within the hopper and/or prior to depositing the refuse materials in the hopper. For example, the hopper may have a partition that can be positioned to direct refuse into one of two storage compartments. One storage compartment can store contaminants, and the other storage compartment can store other refuse. As another example, the hopper may include a robotic arm to place contaminants in a predetermined separate hopper opening configured to receive contaminants and store the contaminants in a separate compartment from other refuse. In some embodiments, the contaminants are separated from other refuse via a conveyor system within the refuse vehicle that directs contaminants into one storage compartment, and other refuse to a different storage compartment. For example, a bidirectional conveyor system can be used to direct contaminants in one direction along the conveyor belt and direct other refuse in a different direction. As another example, a multi-conveyor system can be used, where non-contaminants are deflected from a first conveyor belt to a second conveyor belt for storage in a separate compartment from contaminants. In other embodiments, the contaminant handling system includes a moveable baffle, trap door, or another directing mechanism to redirect contaminants or portions of the refuse material containing contaminants to a separate storage and/or isolation compartment.

In some embodiments, the contaminant handling system may neutralize the contaminants so that the contaminants can be stored in the same compartment as other refuse material. For example, the refuse vehicle may include a shredding device to shred the refuse material received from a refuse container. The refuse vehicle may include an intermediate hopper (e.g., a crucible, etc.) proximate to the shredding device that is configured to store the refuse separately for a predetermined amount of time before transferring the refuse to the storage compartment. The predetermined amount of time may be based on detected contaminants and/or conditions within the intermediate hopper (e.g., whether the contents of the intermediate hopper are at an elevated temperature indicating the presence of a fire, etc.). The hopper may include materials or apparatuses configured to contain risk events associated with shredding the refuse. For example, the hopper can contain fires or explosions caused by shredding contaminants.

In some embodiments, the refuse vehicle is configured to isolate and safely contain the contaminant during transport operations. In some embodiments, the refuse vehicle is a refuse vehicle designed to handle contaminants. For example, if the contaminant is a battery, the refuse vehicle may be specifically equipped to minimize the risk of fire and/or explosion caused by the mishandling of batteries. A battery specialized refuse vehicle may include features such as a thermally resistant body, a specialized packing profile (e.g., to minimize pressure around battery), built in fire suppression devices and/or materials (e.g., a fire suppressing agent, etc.), and/or a climate-controlled storage compartment, among other features. In some embodiments, the refuse vehicle, upon detection of a contaminant, can adjust the packing profile of the storage compartment to reduce a probability of breakage (e.g., due to pressure, surrounding refuse, sharp objects, etc.) around the contaminant.

### Refuse Vehicle

### Front-Loading Configuration

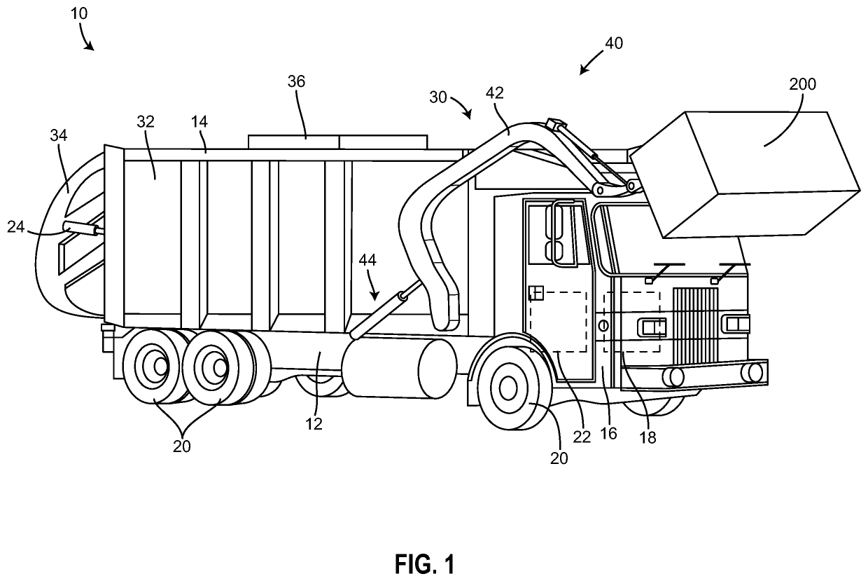

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment 200 as described in greater detail in U.S. Application Ser. No. 17/558,183, filed Dec. 12, 2021, the entire disclosure of which is incorporated by reference herein.

### Rear-Loading Configuration

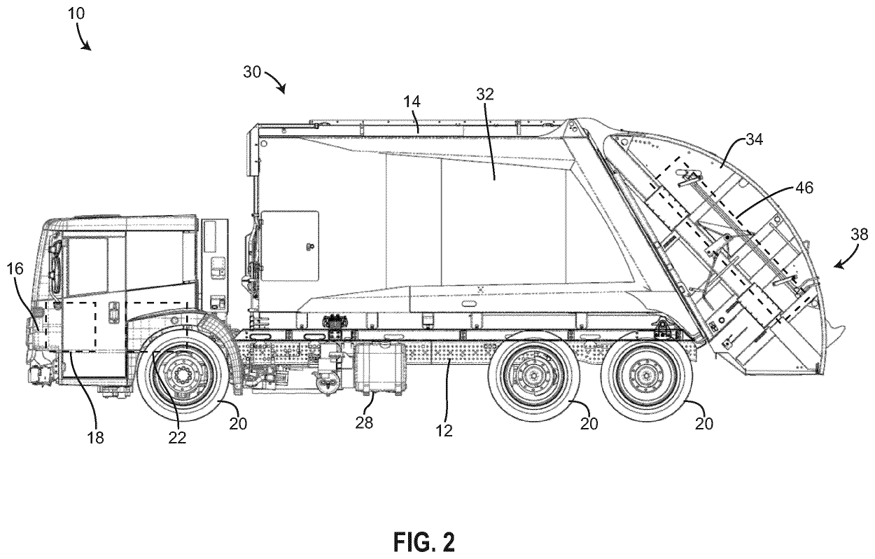

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

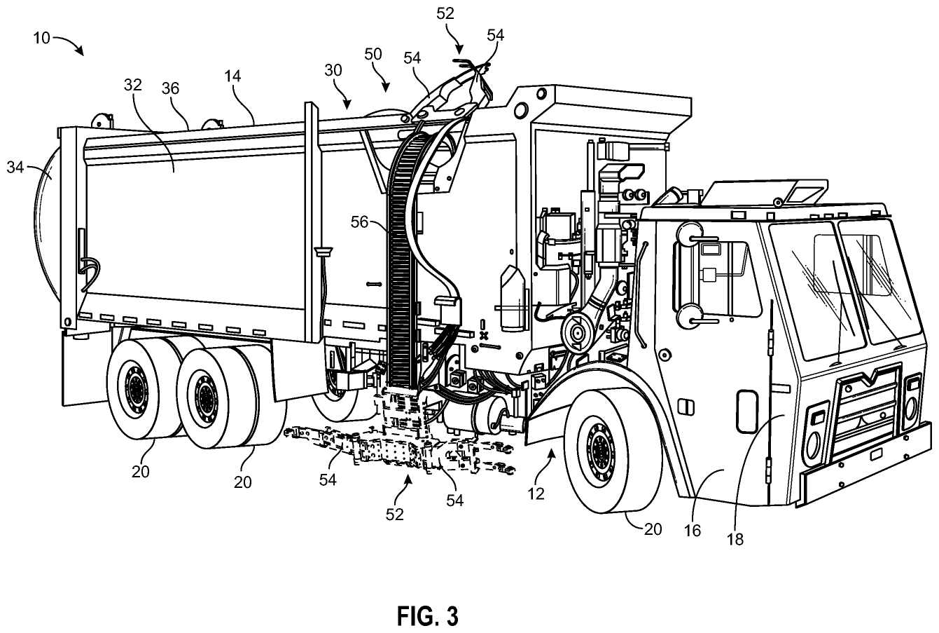

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

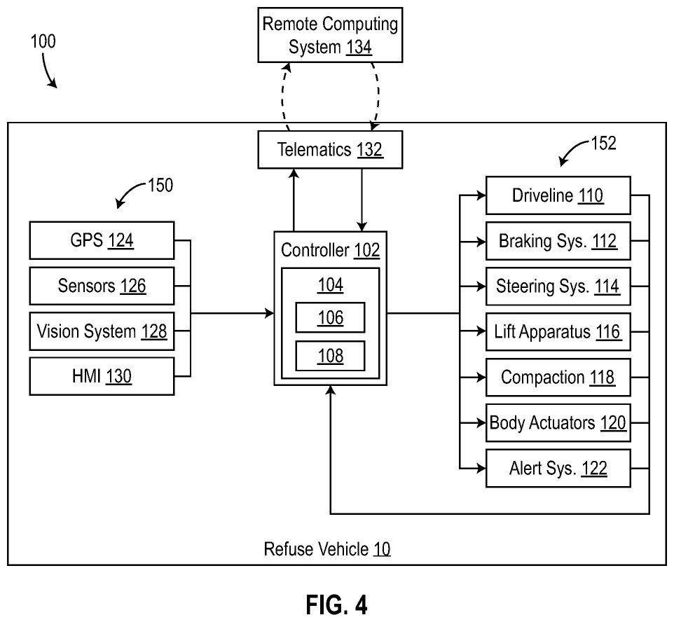

Referring to FIG. 4, the refuse vehicle 10 may include a control system 100 that is configured to facilitate operation of the refuse vehicle 10, or components thereof. In some embodiments, the control system 100 is configured to provide autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS system 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. Application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. Application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. Application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. Application Ser. No. 17/232,855, filed Apr. 16, 2021, the entire disclosure of which is incorporated by reference herein. Although various aspects of autonomous operation may be implemented by the controller 102, it should be understood that the controller 102 may also be configured to facilitate operation of the refuse vehicle by a vehicle operation, for example, based on operator inputs to the HMI 130.

### Contaminant Separation From Refuse Stream and On-Vehicle Storage

As used herein, a “contaminant” may refer to an object in the refuse stream that should be separated from other refuse and/or neutralized before storing with the other refuse in the refuse vehicle. In some embodiments, the contaminant is a battery (e.g., lithium ion (Li-ion) batteries, lead-acid batteries, nickel-cadmium batteries (Ni-Cd), nickel-metal hydride (Ni-MH), and/or other types of batteries). In other embodiments, the contaminant is a different object that should be handled carefully and/or is hazardous to store with other refuse. Although various contaminant detection methods and systems are described herein with respect to batteries, it should be appreciated that the same systems may be implemented to identify various other types of contaminants. For example, and depending on the desired waste materials to be received by the refuse vehicle, the contaminant may include recyclable materials or non-recyclable materials, inorganic waste, chemical waste, and/or various other types of materials or objects.

### Hopper-Based Contaminant Separation

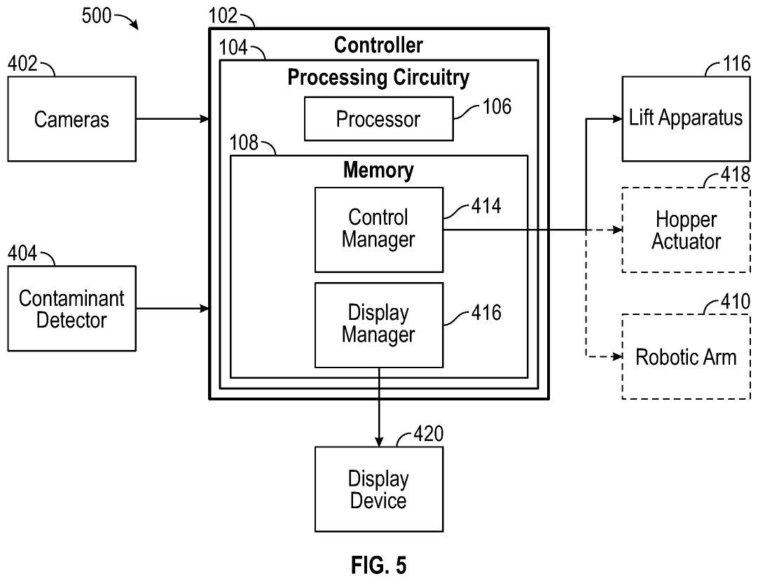

Referring generally to FIGS. 5-9, depicted are embodiments relating to separating contaminants from refuse on the hopper 60 of the vehicle 10. In some embodiments, the hopper 60 includes a hopper actuator configured to direct the refuse into one of two hopper openings of the hopper. In alternate embodiments, the hopper 60 includes a robotic arm configured to sort the refuse and place the refuse into one of the two hopper openings. Each hopper opening provides access to a separate storage compartment disposed within the body of the vehicle 10. One storage compartment is configured to hold non-contaminant refuse, and the other storage compartment is configured to hold contaminant refuse.

Referring to FIG. 5, depicted is a system 500 for hopper (e.g., hopper 60) based contaminant separation for a vehicle, according to an exemplary embodiment. In some embodiments, the vehicle is the refuse vehicle 10. In some embodiments, the vehicle is a different work machine incorporating at least some elements of the refuse vehicle 10. The system 500 is shown to include the controller 102. The controller 102 is shown to include processing circuitry 104, including one or more processors 106 and memory 108. The memory 108 is shown to include a control manager 414 and a display manager 416. The control manager may be communicatively coupled to a lift apparatus 116, a hopper actuator 418, and/or a robotic arm 410. The display manager 416 may be communicatively coupled to a display device 420. The controller 102 may be communicatively coupled to one or more of a camera 402 and a contaminant detector 404. Various embodiments of the system 500 may include other actuators, detectors, devices, or other machinery according to different configurations of the refuse vehicle 10.

The controller 102 may include processing circuitry including one or more processors 106 and memory 108. The controller 102 may facilitate communication between the cameras 402, contaminant detector 404, display device 420, lift apparatus 116, hopper actuator 418, and the robotic arm 410. For example, the controller 102 may receive an indication from the contaminant detector 404 that there is an item (e.g., contaminant) in the refuse that should be separated from the rest of the refuse in the refuse vehicle 10, and operate the hopper actuator 418 to isolate the object. As another example, the controller 102 may receive image data from the cameras 402 corresponding to an image of an isolated object, and transmit the image data for display on the display device 420.

The memory 108 is shown to include a control manager 414. The control manager 414 may control the actuators of the vehicle 10 (e.g., the lift apparatus 116, the hopper actuator 418, the robotic arm 410). The control manager 414 may control the actuators responsive to receiving a notification from the contaminant detector 404. For example, if the contaminant detector 404 notifies the controller 102 that there is an object to be separated from the rest of the refuse, the control manager 414 may operate the hopper actuator 418 and/or robotic arm 410 to isolate the contaminant. In some embodiments, the control manager 414 may control a timing of operation of the actuators to execute a desired operation of the vehicle 10. For example, the control manager 414 may operate the hopper actuator 418 to be in a first position causing isolation of a detected contaminant, and subsequently operate the lift apparatus 116 to deposit the refuse into the hopper.

The memory is shown to include a display manager 416. The display manager 416 may control the display device 420 or a different alerting device (e.g., user interface, alert system, radio system, etc.). The display manager 416 may display information regarding detected contaminants. For example, if the controller 102 receives an indication from the contaminant detector 404 that there is a contaminant in a group of refuse that should be separated from the rest of the refuse, the display manager 416 can display a notification on the display device 420 that notifies an operator of the vehicle 10 that there is a contaminant. The display manager 416 can display status updates regarding operation of the actuators (e.g., lift apparatus 116, hopper actuator 418, robotic arm 410) relating to separating contaminants. For example, after the contaminant is separated, the display manager 416 can display a notification on the display device 420 indicating that the contaminant has been separated (e.g., isolated, removed, neutralized, etc.). The display manager 416 may deploy text notifications, sound notifications, image notifications (e.g., from the cameras 402), or other notifications to alert the operator of the vehicle 10.

The vehicle 10 may include one or more cameras deployed throughout the vehicle 10. For example, the vehicle 10 may include cameras 402 on the lift apparatus 116, hopper 60, robotic arm 410, or other components of the vehicle 10. The cameras 402 may be disposed on the vehicle 10 such that they can capture images (e.g., image, video) relating to detected contaminants. For example, a first camera can capture an image of a contaminant on the lift apparatus 116, a second camera can capture an image of a contaminant in the hopper 60, and a third camera can capture an image of a contaminant in a storage compartment of the vehicle 10. The cameras may be communicatively coupled with the controller 102 to transmit image data to the controller 102 (e.g., for display on the display device 420).

The contaminant detector 404 may detect a contaminant present in refuse being loaded into the vehicle 10. The contaminant detector 404 may be disposed on the vehicle 10 in various locations (e.g., positions) to detect contaminants. For example, the contaminant detector 404 can be disposed on the lift apparatus 116 to detect a contaminant before the refuse is placed in the hopper 60. As another example, the contaminant detector 404 can be disposed on the hopper 60 to detect a contaminant after the refuse is placed in the hopper 60. The contaminant detector 404 may be communicatively coupled to the controller 102 such that the controller 102 can be notified when a contaminant is detected. The contaminant detector 404 may include one or more sensors, such as the cameras 402, or other sensors (e.g., electromagnetic sensors, X-ray scanners, thermal cameras, etc.). For example, the sensors may include particle imaging technology, metal detectors. In some implementations, the sensors may be operated at a range of powers (e.g., varied wavelengths, frequencies, or intensities) to detect contaminants of various types. In some implementations, the sensors may be communicatively coupled with a machine vision system to detect contaminants. In some implementations, the sensors may include a plurality of sensors to determine whether a detected contaminant is a false-positive. For example, a first sensor may detect that an object is a contaminant, but a second sensor may detect that the object is not a contaminant.

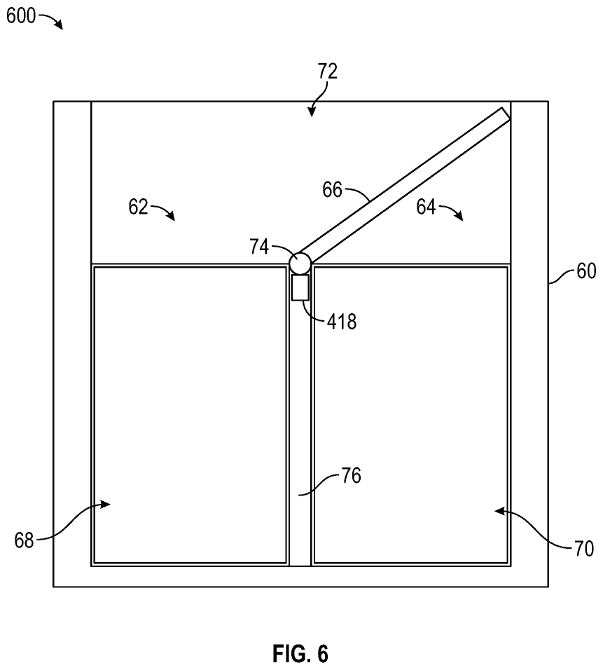

Referring to FIG. 6, depicted is a hopper-based contaminant separation system 600, defining a storage compartment (e.g., an isolation compartment, a neutralization compartment, etc.) to isolate and/or neutralize contaminants received from collected refuse material, according to an exemplary embodiment. The storage compartment configured to hold contaminant refuse may include devices or agents to contain and/or neutralize the contaminant. For example, if the contaminant is a battery, the storage compartment may include a neutralizing agent configured to neutralize battery acid. As another example, the storage compartment may include a fire-suppressant (e.g., oxygen removal apparatus, fire-suppression system, chemicals, sprinklers, etc.) to contain and/or neutralize a fire caused by the contaminant in the storage compartment.

The hopper 60 is shown to include an opening 72, defined by a first hopper opening 62 and a second hopper opening 64. The opening 72 may allow refuse to be emptied into the first hopper opening 62 or the second hopper opening 64. The hopper 60 is shown to include includes a wall 76 that defines a boundary between the first hopper opening 62 and the second hopper opening 64. The first hopper opening 62 provides access to a first compartment 68 within the body 14 of the refuse vehicle 10, while the second hopper opening 64 provides access to a second compartment 70 within the body 14 of the refuse vehicle 10. The first compartment 68 may be a refuse compartment for the collection and transportation of refuse while the second compartment 70 may be a contaminant compartment for the collection and transportation of contaminants. The hopper 60 also includes the partition 66 (e.g., a divider, a panel, a movable member, etc.) that is repositionable between a first position as shown and a second position (e.g., and/or a plurality of intermediate positions between the first position and the second position). When the partition 66 is in the first position, the second hopper opening 64 is restricted (e.g., sealed, blocked, etc.) while the first hopper opening 62 is accessible from the opening 72. Similarly, when the partition 66 is in the second position, the first hopper opening 62 is restricted from access while the second hopper opening 64 is accessible from the opening 72. The partition 66 is shown pivotally coupled with a pivot point 74 at a top of the wall 76 and operably coupled with an actuator 418 (e.g., a partition actuator) such as an electric motor, a hydraulic cylinder, etc. The pivotal coupling and rotation of the partition 66 as shown and described herein with reference to FIG. 6 is illustrative only and should not be understood as limiting. For example, the partition 66 may be formed by a pair of trap doors that each limit or allow access to a corresponding one of the first hopper opening 62 or the second hopper opening 64 and are independently operable to transition between an open state or a closed state. In some embodiments, the operability of the partition 66 between a first position and a second position or a first orientation and a second orientation is optional if the lift apparatus 116 is capable of operating to empty contents of the refuse containers 200 into the first hopper opening 62 or the second hopper opening 64.

In some embodiments, the hopper 60 can include a neutralizing agent (e.g., powder, mist, liquid, etc.) to prevent combustion and/or chemical reactions associated with contaminants. For example, the hopper 60 can apply the neutralizing agent to the contaminants upon being placed in the hopper 60. The neutralizing agent can remain applied to the contaminants both while in the hopper 60, and while in a storage compartment during transit operations, allowing for reduced probability of combustion or reaction both while storing the contaminants and while transporting the contaminants.

By default (e.g., as a starting position), the partition 66 may be in the first position, to allow refuse to be directed to the first compartment 68, while not allowing refuse to be directed to the second compartment 70. When the controller (e.g., controller 102) receives an indication (e.g., from the contaminant detector 404) that refuse being loaded into the hopper 60 includes a contaminant, the controller may operate the hopper actuator 418 to shift the partition 66 to the second position to cause refuse to be directed to the second compartment 70, while not allowing refuse to be directed to the first compartment 68. In some embodiments, the indication is received by the controller before the refuse is deposited into the hopper 60 so that the partition 66 is in the correct position when the refuse is deposited.

In some embodiments, after the partition 66 is moved to the second position and the refuse and contaminant are directed to the second compartment 70, the hopper actuator 418 is configured to move the partition 66 back to the first position, thereby closing off (e.g., covering, sealing, enclosing) the second compartment 70. Once the partition 66 is back into the first position, the contents of the second compartment 70 may be neutralized. In some embodiments, the second compartment 70 includes a shredding device to shred the contents of the compartment. The second compartment may include fire-suppressant materials to contain or otherwise terminate a fire caused by the shredding device. In some embodiments, the second compartment 70 may release a neutralizing agent onto the contents of the second compartment 70. For example, the second compartment 70 may to release a sodium bicarbonate agent (e.g., powder, solution) to neutralize acids (e.g., battery acid) present in the contaminant.

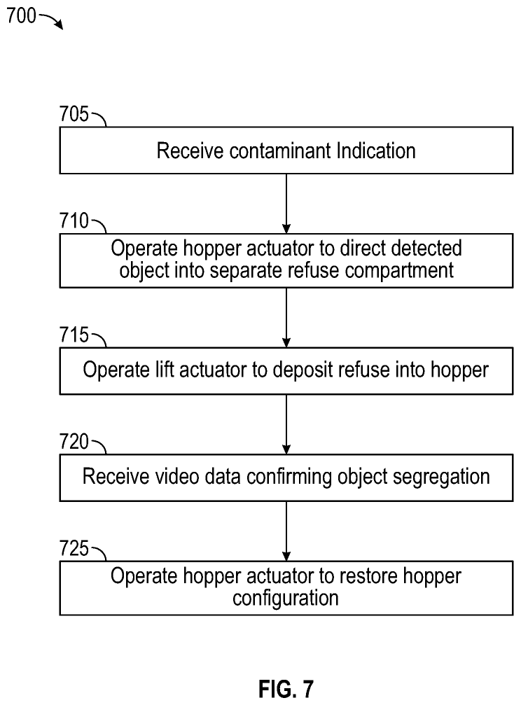

Referring to FIG. 7, a flow diagram of a method 700 for hopper-based contaminant separation is shown, according to an exemplary embodiment. At step 705, a controller (e.g., controller 102) receives an indication (e.g., from the contaminant detector 404) that refuse being loaded into the vehicle 10 includes a contaminant that should be separated from the other refuse in the vehicle 10. The indication may include a contaminant type (e.g., battery, flammable object, other hazardous object), a contaminant size, a risk type (e.g., flammable, acid, sharp, etc.) and/or another characteristic or condition of the contaminant. At step 710, the controller may operate the hopper actuator (e.g., hopper actuator 418) to position a partition (e.g., partition 66) of the hopper 60 such that refuse deposited into the hopper 60 is directed into a separate refuse compartment (e.g., second compartment 70). The hopper actuator may position the partition to restrict a main refuse compartment (e.g., first compartment 68) from receiving refuse.

At step 715, the controller is configured to operate a lift actuator of a lift apparatus (e.g., lift apparatus 116) to deposit the refuse into the hopper 60. In some embodiments, the lift apparatus may deposit the refuse after a delay period (e.g., corresponding to movement of the partition),, thereby preventing the refuse from becoming lodged between the partition and a wall of the hopper, which may restrict a flow of refuse into the separate refuse compartment. At step 720, the controller may receive video data from cameras (e.g., cameras 402) or other sensors indicative of the contaminant being deposited into the separate refuse compartment, which can provide confirmation that the contaminant has been properly isolated or otherwise disposed of. The cameras may be positioned in the hopper, the separate refuse compartment, the lift apparatus, or a different part of the vehicle in view of the contaminant. Upon receiving the video data, the controller may confirm that the contaminant was placed into the separate refuse compartment. In some embodiments, the controller can display the video data on a display device (e.g., display device 420) and request operator authorization from the operator of the vehicle 10 that the contaminant has been separated from the remainder of the refuse material being loaded onto the vehicle.

At step 720, the controller can operate the hopper actuator to restore the partition to cover the separate refuse compartment and allow refuse to be directed into the main refuse compartment. While the partition is being moved to cover the separate refuse compartment, the controller may prevent the lift apparatus from depositing refuse into the hopper. Upon restoring the partition to cover the separate refuse compartment, the controller can instruct the lift apparatus to continue depositing refuse into the hopper.

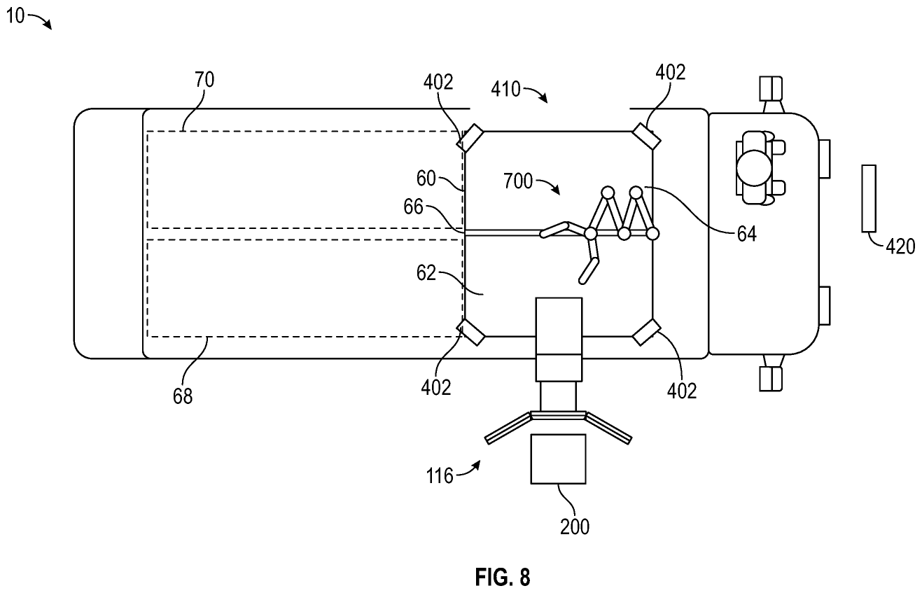

Referring to FIG. 8, depicted is the refuse vehicle 10 with a hopper-based robotic arm contaminant separation system, according to an exemplary embodiment. In some embodiments, the hopper 60 includes a fixed (e.g., immovable, rigid) partition 66 separating the first hopper opening 62 and the second hopper opening 64. The first hopper opening 62 may allow access to the first storage compartment 68 and the second hopper opening 64 may allow access to the second storage compartment 70. The vehicle 10 is shown to include the lift apparatus 116. The lift apparatus 116 may lift the refuse container 200 and deposit its contents into the hopper 60. In some embodiments, the first hopper opening 62 and/or the second hopper opening 64 may include a removable lid (e.g., trap door, floor, surface, etc.) to allow the lift apparatus 116 to deposit the contents of the refuse container 200 into the hopper 60, without the refuse entering the first storage compartment 68 and/or the second storage compartment 70. For example, when the lift apparatus 116 is depositing the contents of the refuse container into the first hopper opening 62, the removable lid of the second hopper opening 64 may remain closed.

The vehicle 10 is shown to include the robotic arm 410 positioned on the exterior of the vehicle 10. In some embodiments, the robotic arm 410 is mechanically coupled to the partition 66. In some embodiments, the robotic arm 410 is mechanically coupled to a different part of the exterior of the vehicle 10 (e.g., roof, exterior wall). The robotic arm 410 may be positioned on the exterior of the vehicle 10 such that the robotic arm 410 can extend across both the first hopper opening 62 and the second hopper opening 64. The robotic arm 410 can include one or more prongs (e.g., forks, claws, grabbers) configured to lift an object in one location of the hopper 60, and transfer the object to another location in the hopper 60.

In some embodiments, the lift apparatus 116 can deposit the refuse of the refuse container 200 into the first hopper opening 62. Before and/or after depositing the refuse of the refuse container 200 into the first hopper opening 62, a contaminant detector (e.g., contaminant detector 404) can determine whether there is an object (e.g., contaminant) present in the refuse that should be separated from the rest of the refuse (e.g., not placed in the first storage compartment 68). The contaminant detector can communicate with the robotic arm 410 via the controller 102 and notify the robotic arm 410 that there is a contaminant.

In some embodiments, the robotic arm 410 may automatically separate the contaminant from the rest of the refuse. The robotic arm 410 can receive information regarding the contaminant to selectively remove the contaminant from the refuse stream. For example, upon identifying the contaminant, the robotic arm 410 can lift the contaminant out of the first hopper opening 62, and place the contaminant in the second hopper opening 64, thereby allowing the contaminant to be stored in the second storage compartment 70. In some embodiments, the robotic arm 410 may be operated manually by an operator of the vehicle 10. For example, the display device 420 can be configured to display video data from the cameras 402 and identifying information of the contaminant, which allows the operator to manually identify the contaminant and control the robotic arm 410 to separate the contaminant from the refuse stream.

The operator can control the robotic arm 410 to lift the contaminant out of the first hopper opening 62, and place it in the second hopper opening 64. In some embodiments, the robotic arm 410 may selectively identify and isolate the contaminant from the rest of the refuse. In some embodiments, upon detection of a contaminant, the robotic arm 410 may move all of the refuse from the first hopper opening 62 to the second hopper opening 64. Once the contaminant is placed into the second hopper opening 64, a covering (e.g., lid, floor, surface) of the first hopper opening 62 and/or second hopper opening 64 can be opened (e.g., removed, retracted) to allow the contents of the hopper 60 to enter the first storage compartment 68 and the second storage compartment 70.

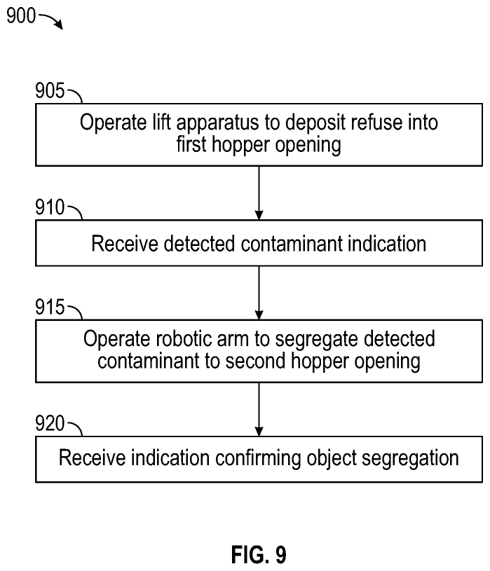

Referring to FIG. 9, depicted is a flow diagram of a method 900 for separating contaminants from a refuse stream using a robotic arm, according to an exemplary embodiment. At step 905, a controller can operate a lift apparatus (e.g., lift apparatus 116) to deposit the refuse of a refuse container (e.g., refuse container 200) into a first hopper opening (e.g., first hopper opening 62). The first hopper opening can include a floor or surface to hold or otherwise contain the refuse. At step 910, the controller can receive an indication of a detected object (e.g., contaminant) that should be separated from the rest of the refuse. The indication can include identifying information of the contaminant (e.g., appearance, contaminant type, risk type, etc.).

At step 915, the controller may operate a robotic arm (e.g., robotic arm 410) to segregate the detected contaminant to a second hopper opening (e.g., second hopper opening 64). The robotic arm can be operated automatically by the controller and/or operated manually by an operator of the vehicle via a display device (e.g., display device 420). At step 920, the controller can receive an indication that the contaminant separation was successful. In some implementations, in response to receiving an indication of successful separation, the controller can display a video on the display device showing that the contaminant was placed in the second hopper opening.

### Conveyor System Contaminant Separation

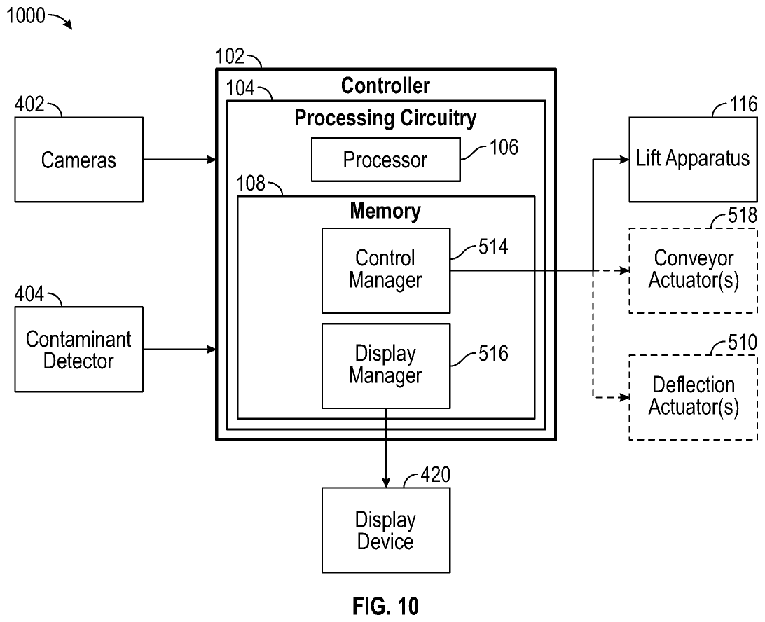

Referring generally to FIGS. 10-14, depicted are embodiments relating to separating contaminants from refuse via a conveyor system of the vehicle 10. In some embodiments, the conveyor system includes one or more conveyor belts configured to move refuse within the body of the vehicle 10. Each conveyor belt may include one or more conveyor actuators configured to move the refuse along the conveyor belt and/or configured to rotate (e.g., pivot) the conveyor belt around a center point. The conveyor system may include one or more deflectors configured to redirect objects to different locations in the vehicle 10.

Referring to FIG. 10, depicted is a control system 1000 for separating contaminants from a refuse stream via a conveyor system of the vehicle 10, according to an exemplary embodiment. In some embodiments, the system 1000 may include some/all of the features of the system 500, such as the controller 102, lift apparatus 116, cameras 402, contaminant detector 404, and the display device 420. The system 1000 can incorporate any of the features and functions of the system 500. The controller 102 is shown to include processing circuitry 104 including one or more processors 106 and memory 108. The memory 108 includes a control manager 514. The control manager 514 can incorporate any of the features of the control manager 414, among other features. The memory 108 is also shown to include the display manager 516. The display manager 516 can incorporate any features of the display manager 416, among other features. The system 1000 is shown to optionally include one or more conveyor actuators 518 to control one or more conveyor belts. The system 1000 is shown to optionally include one or more deflection actuators 510 to redirect objects on the conveyor belts.

The controller 102 can to operate the lift apparatus 116 to deposit refuse into an opening of the body of the vehicle 10. Upon entering the vehicle 10, the refuse can be placed on a conveyor system including one or more conveyor belts. The controller 102 can operate or otherwise control one or more conveyor actuators 518 to move the refuse in one or more directions along the conveyor belts. In some embodiments, the conveyor system includes one or more deflectors configured to redirect the refuse in the conveyor system. The deflectors may be moved by one or more deflection actuators 510, so that the deflection of refuse can be selectively handled or otherwise controlled by the controller 102.

The contaminant detector(s) 404 may be disposed along the conveyor belt system. As refuse moves along the conveyor belt(s), the contaminant detectors 404 may determine that a contaminant is present. The controller 102 may receive an indication (e.g., signal, notification, alert) from the contaminant detector 404 that an object in the refuse stream is a contaminant and should be separated (e.g., removed, segregated, etc.) from the refuse stream.

Responsive to a determination that there is a contaminant present on the conveyor system, the control manager 514 may operate the conveyor actuator(s) and/or the deflection actuator(s) to separate the contaminant from the refuse stream. For example, the conveyor actuator 518 may alter the direction of the refuse stream to deposit (e.g., place, drop) the refuse into a separate container (e.g., storage compartment, bag, chamber). As another example, the deflection actuator(s) may redirect the contaminant to the separate container that is separated from a primary refuse storage compartment in the refuse vehicle.

The display manager 516 may display information relating to the separation of contaminants from the refuse stream to the display device 420. For example, the cameras 402 may transmit video and/or image data to the controller 102, and the display manager 516 can display the video to the display device 420. As another example, the display manager 516 may display prompts to the display device 420 requesting operator authorization to complete operations and/or to provide manual intervention to remove the contaminant from the refuse stream.

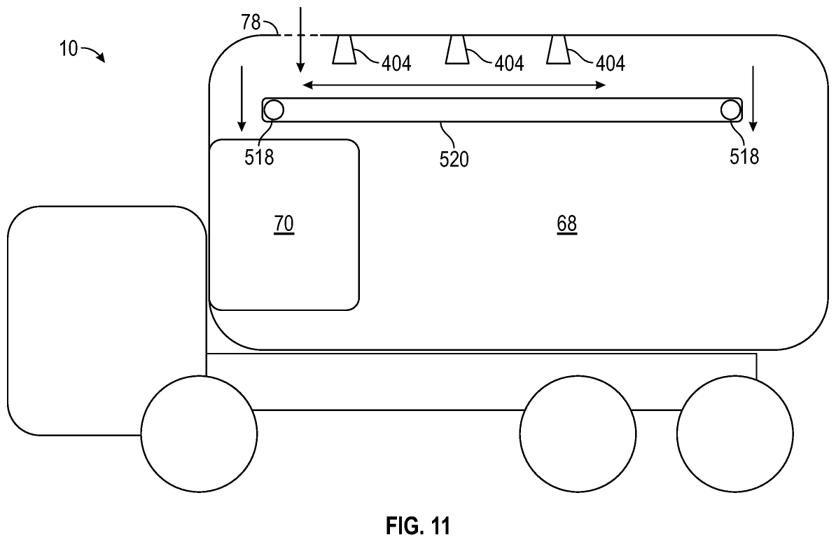

Referring to FIG. 11, depicted is the vehicle 10 with a bidirectional conveyor system for contaminant separation, according to an exemplary embodiment. The vehicle 10 is shown to include a refuse opening 78 to receive refuse. Although shown to be on a top portion of the vehicle 10, the refuse opening 78 could be on a different location of the vehicle 10 (e.g., side portion, back portion). The vehicle 10 is shown to include the first storage compartment 68. The second storage compartment 70, conveyor belt 520, conveyor actuators 518, and contaminant detectors 404, although shown to be disposed within the first storage compartment 68, could also be disposed in a separate section of the vehicle 10 outside of the first storage compartment 68. In some embodiments, the refuse opening 78 is coupled to a device configured to control the flow of refuse through the refuse opening to prevent overcrowding of the conveyor belt 520.

In some implementations, the refuse opening 78 can receive refuse from outside of the vehicle 10. Once the refuse is deposited into the refuse opening 78, the refuse is placed (e.g., falls, is deposited, rests) on the conveyor belt 520. The conveyor belt 520 includes one or more conveyor actuators configured to translate a surface of the conveyor belt 520. When the surface of the conveyor belt 520 translates, the refuse resting on the conveyor belt 520 moves along the conveyor belt 520. As the refuse moves along the conveyor belt 520, the contaminant detectors 404 can detect contaminants present on the conveyor belt 520.

If the contaminant detectors 404 detect a contaminant (e.g., battery), the conveyor actuators 518 may change direction, thereby reversing the direction of refuse flow. For example, the movement of the conveyor belt 520 surface can be directed towards the second storage compartment 70. The conveyor actuators 518 can continue the reversal of refuse flow until the contaminant is deposited into the second storage compartment 70. The contaminant detectors 404 can determine whether the contaminant was successfully deposited into the second storage compartment 70, and can subsequently cause the conveyor actuators to restore normal refuse flow and direct the refuse for storage in the first storage compartment 68.

Additionally, or alternatively, upon a determination by the contaminant detectors 404 that a contaminant is present on the conveyor belt 520, the operator can be notified (e.g., via the display device 420) that there is a contaminant present. The conveyor actuators 518 may stop the flow of refuse (e.g., by stopping movement of the conveyor belt 520) until the operator manually removes the contaminant from the conveyor belt 520. For example, if the contaminant detectors determine that there is a battery on the conveyor belt 520, the conveyor actuators 518 can be disabled until the operator removes the battery from the refuse flow. The operator can be notified of the contaminant by an alert being displayed on the display device 420. The display device 420 can require operator acknowledgement that the contaminant has been handled (e.g., removed) before transit operations can be resumed.

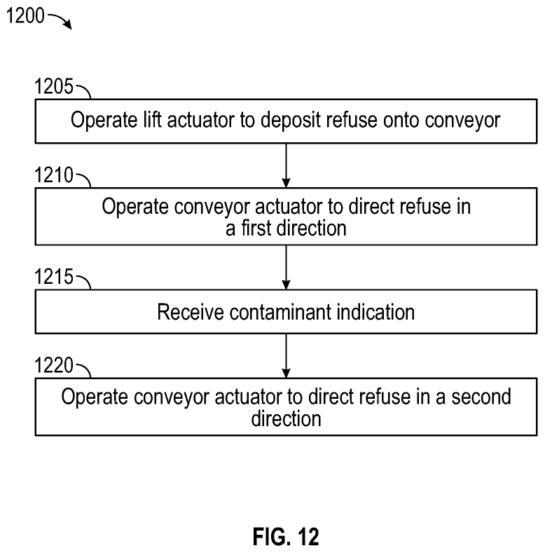

Referring to FIG. 12, depicted is a flow diagram of a method 1200 for contaminant separation using a bidirectional conveyor belt, according to an exemplary embodiment. At step 1205, a controller (e.g., controller 102) operates a lift apparatus (e.g., lift apparatus 116) to deposit refuse onto a conveyor belt (e.g., conveyor belt 520) of a vehicle (e.g., vehicle 10). The lift apparatus may deposit the refuse onto the conveyor belt at a controlled rate, to prevent overcrowding on the conveyor belt. At step 1210, the controller operates a conveyor actuator (e.g., conveyor actuator 518) to direct the refuse in a first direction along the conveyor belt. The first direction of the conveyor belt may direct the refuse towards a main storage compartment (e.g., first storage compartment 68).

At step 1215, the controller may receive a contaminant indication (e.g., from the contaminant detector 404). The indication may include descriptive features of the contaminant, thereby allowing the controller to identify the contaminant on the conveyor belt. At step 1220, the controller may operate the conveyor actuator to direct the flow of refuse on the conveyor belt in a second direction (e.g., a reverse direction). The second direction of the conveyor belt may direct the refuse towards a secondary storage compartment (e.g., second storage compartment 70). The secondary storage compartment may be isolated or otherwise separated from the main storage compartment. In response to the contaminant being deposited into the secondary storage compartment, the controller may operate the conveyor actuator to restore the direction of conveyor belt motion to the first direction (e.g., towards the main storage compartment).

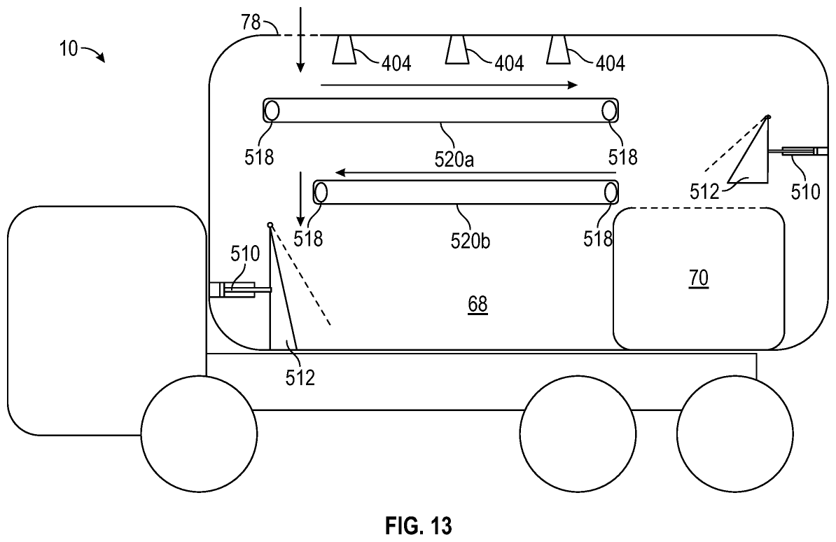

Referring to FIG. 13, depicted is a diagram of the vehicle 10 with a multi-stage conveyor system including one or more deflectors, according to an exemplary embodiment. The vehicle 10 is shown to include the refuse opening 78 configured to receive or otherwise accept refuse at a controlled rate. The vehicle 10 is shown to include the first storage compartment 68. The second storage compartment 70, first conveyor belt 520a, second conveyor belt 520b, conveyor actuators 518, and contaminant detectors 404, although shown to be disposed within the first storage compartment 68, could also be disposed in a separate section of the vehicle 10 outside of the first storage compartment 68. The first conveyor belt 520a is configured such that refuse being received by the refuse opening 78 is deposited onto the first conveyor belt 520a. The first conveyor belt 520a is shown to include conveyor actuators 518. Although two conveyor actuators 518 are shown, the first conveyor 516a can have any number of conveyor actuators 518.

The conveyor actuators 518 are configured to move or otherwise rotate the surface of the first conveyor belt 520a such that the refuse on the first conveyor belt 520a move in a first direction. As the refuse translates along the first conveyor belt 520a in the first direction, the contaminant detectors 404 can determine whether there is a contaminant present on the conveyor belt 520a. If a contaminant is detected, the deflector actuator 510 can retract, allowing refuse to fall from or otherwise leave the first conveyor belt 520a and enter the second storage compartment 70 without coming into contact with the deflector 512. In some embodiments, the rate of extension/retraction the deflector actuator 510 is configured to match the rate of the first conveyor belt 520a. This may allow for selectively retracting/extending the deflector 512 such that only detected contaminants are deposited into the second storage compartment 70. For example, if a contaminant is detected and the deflector is in an extended position, the speed of the deflector actuator 510 can retract at a rate such that only the detected contaminant can enter the second storage compartment 70.

If no contaminant is detected on the first conveyor belt 520a, a deflector actuator 510 may extend the deflector 512 to a length where the refuse on the first conveyor belt 520a can be deflected onto a second conveyor belt 520b. Once the refuse is deflected onto the second conveyor belt 520b, the conveyor actuators 518 can operate such that the refuse is moved or otherwise translated in a second direction. The second direction may be any direction that does not lead towards the second storage compartment 70. For example, the second direction may allow the refuse to be deposited in the first storage compartment 68.

In some embodiments, once the refuse is placed (e.g., dropped, loaded, deposited) into the first storage compartment 68, a deflector 512 may be used or otherwise positioned to move the refuse within the first storage compartment 68. This may prevent overcrowding in specific areas of the first storage compartment 68, particularly in areas near the end of the second conveyor belt 520b. The deflector 512 can include a deflector actuator 510, that can be extended/retracted to arrange contents within the first storage compartment 68. In some embodiments, the deflectors 512 can be wedge-shaped. In alternate embodiments, the deflectors 512 can be any shape capable of moving, compacting, and/or shifting refuse.

In some embodiments, as the refuse translates along the first conveyor belt 520a, the contaminant detectors 404 may identify a contaminant and/or a quantity of refuse containing a contaminant. The vehicle 10 may include a piston actuator configured to push or otherwise direct the refuse containing the contaminant into the second storage compartment 70. For example, as the refuse travels in the first direction along the conveyor belt 520a, the piston actuator can push refuse in a direction perpendicular to the conveyor belt 520a. The second storage compartment 70 can be placed in a location of the vehicle 10 such that when the refuse is pushed from the conveyor belt 520a, the refuse lands in the second storage compartment 70.

In some embodiments, the conveyor belt 520a can act as a partition between the first storage compartment 68 and the second storage compartment 70. The vehicle 10 can include a first piston actuator configured to push refuse from the conveyor belt 520a in a first direction perpendicular to the direction of refuse flow towards the first storage compartment 68. The vehicle 10 can include a second piston actuator configured to push refuse from the conveyor belt 520a in a second direction perpendicular to the direction of refuse flow towards the second storage compartment. As refuse travels along the conveyor belt 520a, the contaminant detectors 404 may identify the refuse as being either a contaminant material or non-contaminant material. Based on the identification by the contaminant detectors 404, one of the piston actuators may be deployed to push refuse from the conveyor belt into one of the storage compartments.

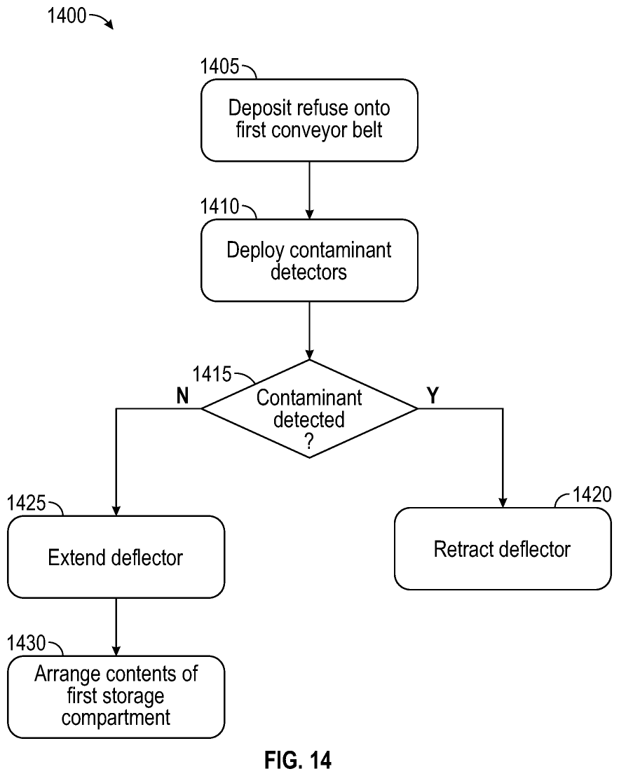

Referring to FIG. 14, depicted is a flow diagram for a method 1400 of using a multi-stage conveyor system for contaminant separation, according to an exemplary embodiment. At step 1405, refuse may be deposited onto a first conveyor belt (e.g., first conveyor belt 520a). The conveyor belt may translate the refuse in a first direction towards a secondary storage compartment (e.g., second storage compartment 70). At step 1410, as refuse moves across the first conveyor belt, contaminant detectors (e.g., contaminant detectors 404) are deployed to scan or otherwise examine the refuse for potential contaminants. The contaminant detectors may transmit data to a controller (e.g., controller 102) indicating whether a contaminant is present on the first conveyor belt.

At step 1415, the controller processes or otherwise analyzes the data from the contaminant detectors to determine whether there is a contaminant present on the first conveyor belt. The controller may determine an exact location of the contaminant on the first conveyor belt, or determine that there is a contaminant anywhere on the first conveyor belt. At step 1420, if a contaminant is detected, a deflector (e.g., deflector 512) may be retracted such that at the end of the first conveyor belt, the refuse falls into a secondary (e.g., separate, isolated) storage compartment. At step 1425, if a contaminant is not detected, the deflector may be extended such that at the end of the first conveyor belt, the refuse is deflected onto a second conveyor belt (e.g., second conveyor belt 520b). The second conveyor belt may direct or otherwise translate the refuse for storage at a location in a main storage compartment (e.g., first storage compartment 68). At step 1430, once the refuse has reached the end of the second conveyor belt and is in the main storage compartment, a second deflector may be deployed to rearrange contents of the main storage component. This may prevent overcrowding (e.g., blockage) of refuse near the end of the second conveyor belt.

### Shred-Based Contaminant Neutralization

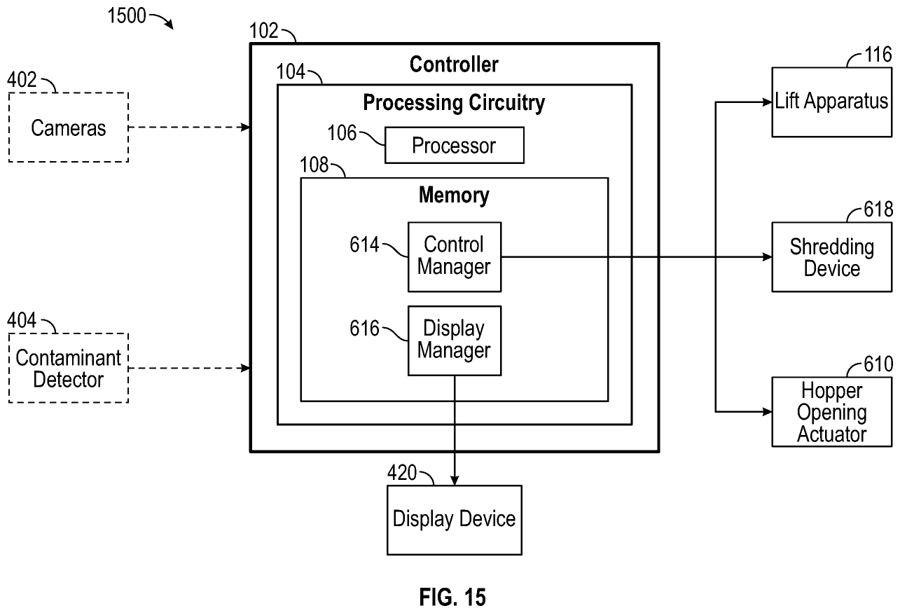

Referring generally to FIGS. 15-17, depicted are systems and methods of neutralizing contaminants in a refuse stream for a refuse vehicle by shredding refuse using a shredding device. In some embodiments, only refuse that is determined to include contaminants are shredded. In alternate embodiments, all refuse that enters the refuse vehicle is shredded. A shredding device may include any device capable of dismantling (e.g., tearing, ripping, cutting, fragmenting, flattening) or otherwise destroying refuse. To avoid damage to the refuse vehicle caused by any fires or explosions that occur while and/or after shredding materials, shredded materials may be stored in fire-proof containers and/or the walls of the refuse vehicle themselves may be constructed using fire-proof materials.

Referring to FIG. 15, depicted is a control system 1500 for neutralizing contaminants in a refuse stream of the vehicle 10 by shredding refuse, according to an exemplary embodiment. In some embodiments, the system 1500 includes some/all of the features of the systems 500 and 1000, such as the controller 102, lift apparatus 116, cameras 402, contaminant detector 404, and the display device 420. The controller is shown to include processing circuitry 104 including one or more processors 106 and memory 108. The memory 108 includes a control manager 614. The control manager 614 can incorporate any of the features of the control manager 414 and/or control manager 514, among other features. The memory 108 is also shown to include the display manager 616. The display manager 616 can incorporate any features of the display manager 416 and/or display manager 516, among other features. The system 1000 is shown to include one or more shredding devices 618 configured to shred refuse. The system 1500 is shown to include one or more hopper opening actuators 610 configured to open/close off a hopper configured to hold shredded material.

The controller 102 can operate the lift apparatus 116 to deposit refuse into the hopper 60. Upon entering the hopper 60, the controller 102 can operate or otherwise cause the hopper opening actuator 610 to cover a top portion of the hopper (e.g., the intermediate hopper, etc.), such that the environment inside of the hopper 60 is sealed off from the environment outside of the hopper 60. The refuse material can subsequently be shredded by the shredding device 618. The controller 102 can operate or otherwise control the shredding device 618 to shred the refuse material in a desired manner. For example, depending on the refuse type (contaminant, non-contaminant, battery, chemicals, etc.), the shredding device 618 may have different shredding settings to shred the refuse. After the refuse is shredded, the controller 102 may determine a period of time to keep the shredded refuse in the hopper 60. This may be to ensure that any fires or explosions that occur as a result of shredding the refuse is contained within the hopper 60. The hopper 60 may include a crucible made from or including a fire-proof and/or explosion-proof material configured to withstand fires and/or explosions. Additionally, or alternatively, the hopper 60 may include other materials such as acid neutralizing agents; fire extinguishing and/or suppressing agents, such as dry powders made from ammonium phosphate-based compounds and/or other materials, oxygen removal apparatuses (e.g., a vacuum pump coupled to the hopper), and/or other systems to neutralize the shredded refuse and minimize the risk of fire/explosion/chemical leeching once the refuse leaves the hopper 60.

In some embodiments, contaminant detector(s) 404 may be disposed on the vehicle 10. As refuse enters the hopper 60, the contaminant detectors 404 may determine that a contaminant is present. The controller 102 may receive an indication (e.g., signal, notification, alert) from the contaminant detector 404 that an object in the refuse stream is a contaminant. The indication may include a contaminant type. The controller 102 may then determine a desired shredding operation based on the detected contaminant. For example, if the contaminant is a battery, the controller 102 may determine a desired fineness for shredding. Additionally or alternatively, the controller may determine a desired length of time to keep the shredded refuse in the hopper 60 after shredding. For example, if the contaminant is a battery, the controller may keep the shredded refuse in the hopper for a predetermined length of time to allow any fire/explosions that occur to be contained in the hopper 60. After the determined length of time for keeping the refuse in the hopper 60, the control manager 614 may operate a hopper opening actuator 610 to allow the refuse to enter a main compartment of the vehicle 10. For example, the hopper opening actuator 610 may open a bottom portion (e.g., floor surface) of the hopper 60 to allow the refuse to enter a compartment of the vehicle 10 for storing the shredded refuse.

The display manager 516 can display information relating to the shredding of contaminants to the display device 420. For example, the cameras 402 may transmit video and/or image data to the controller 102, and the display manager 516 can display the video to the display device 420. As another example, the display manager 516 may display prompts to the display device 420 requesting operator authorization to complete operations, such as shredding contaminants or opening/closing the hopper, among other examples.

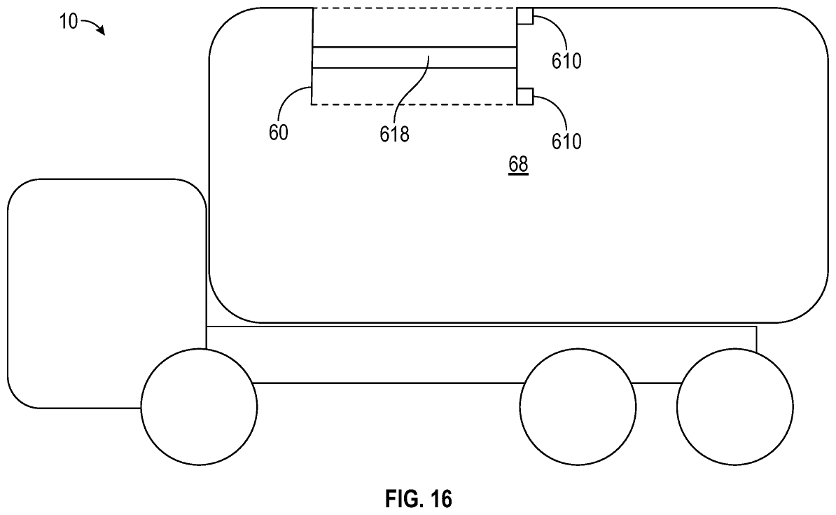

Referring to FIG. 16, depicted is the refuse vehicle 10 with a shredding device within the hopper 60, according to an exemplary embodiment. The vehicle 10 is shown to include the hopper 60, with a shredding device 618 positioned within the hopper 60. The hopper 60 is shown to include a hopper opening actuator 610 on a top portion and a bottom potion of the hopper 60. The top hopper opening actuator 610 may allow access to the hopper 60 from an area outside of the vehicle 10. The bottom hopper opening actuator 610 may allow access to the hopper 60 from the first storage compartment of the vehicle 68. For example, the top hopper opening actuator 610 may allow refuse to be deposited into the hopper 60, and the bottom hopper opening actuator 610 may allow refuse to be deposited from the hopper 60 into the first storage compartment 68.

The hopper 60 may receive refuse from an area outside of the vehicle 10. Upon receiving the refuse, the top hopper opening actuator 610 may close a top portion of the hopper 60 to the environment outside of the vehicle 10. Once the top portion of the hopper 60 is closed, the shredding device 618 can shred the refuse inside of the hopper 60. In some embodiments, the shredding device 618 a shredding device 618 of the robotic arm 410. In some embodiments, the shredding device 618 is a different type of industrial shredder. After the refuse is shredded, the refuse can pass through the shredding device 618 and rest on a bottom portion of the hopper 60. Depending on the determined shredding operation, the shredded refuse may be kept in the bottom of the hopper 60 for a predetermined amount of time. The amount of time that the shredded refuse is kept in the hopper 60 may depend on whether a contaminant was detected in the refuse. For example, if a battery (e.g., or other flammable material) is detected in the refuse, the refuse may be kept in the hopper 60 for an amount of time corresponding to a battery fire. To reduce the amount of time that the refuse is kept in the hopper 60, materials may be applied to the hopper (e.g., fire-reducing agents, acid neutralizing agents, oxygen removal agents, etc.).

After the predetermined amount of time passes, the bottom portion of the hopper 60 may be opened or otherwise removed by a bottom hopper opening actuator 610. Once the bottom hopper opening actuator 610 opens the hopper 60, the contents of the hopper 60 can pass into the first storage compartment 68. Subsequently, the top hopper opening actuator 610 can open the top portion of the hopper 60, and the bottom hopper opening actuator can close the bottom portion of the hopper 60, thereby allowing the hopper 60 to be reloaded with refuse.

In some embodiments, the shredding device 618 may not be located in the hopper 60, but rather in a separate container external to the first storage compartment 68. For example, the shredding device 618 can be positioned in a container on the top portion of the body of the vehicle 10. After the refuse is shredded in the separate container, the refuse can be transferred to the hopper 60 for storage in the first storage compartment 68. Shredding the refuse in a separate container may allow for selective shredding of refuse. For example, if a contaminant is detected in refuse being loaded into the vehicle, the refuse can be loaded (e.g., by the lift apparatus 116) into the separate container, rather than directly into the hopper 60. In some embodiments, the hopper 60 may include a crucible or incinerator to facilitate the safe combustion of the contaminant. Some contaminants may be at risk of combusting and/or exploding while stored in a storage compartment of the vehicle 10. By configuring the hopper to facilitate combustion, the risk of combustion occurring in the storage compartment 68 can be decreased.

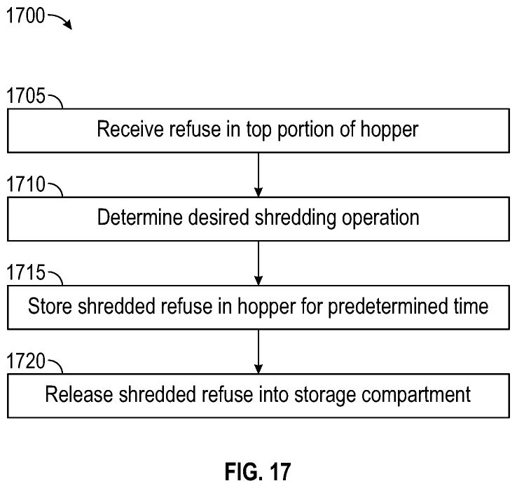

Referring to FIG. 17, depicted is a flow diagram for neutralizing contaminants by shredding refuse in a refuse vehicle, according to an exemplary embodiment. At step 1705, the vehicle (e.g., refuse vehicle 10) may receive refuse at the top portion of a hopper (e.g., hopper 60). Once the refuse is inside of the top portion of the hopper, the top portion of the hopper may be closed or otherwise restricted such that the contents of the hopper do not interact with the environment outside of the hopper. At step 1710, a controller of the vehicle may determine a desired shredding operation. The shredding operation of the vehicle may be based on the determination of a contaminant within the refuse stream. Specifically, the shredding operation may be based on the determination of any contaminant, or the determination of a specific contaminant within the refuse. After determining the shredding operation, a shredding device may shred the refuse according to the determined operation.

At step 1715, after shredding, the hopper may store the shredded refuse in a bottom portion of the hopper. The hopper may store the refuse in a bottom portion of the hopper for a predetermined amount of time corresponding to the shredding operation. For example, a first shredding operation may involve storing the shredded refuse in the bottom portion of the hopper for a first period of time, and a second shredding operation may involve storing the shredded refuse in the bottom portion of the hopper for a second period of time. At step 1720, the bottom portion of the hopper may be opened or otherwise released such that the contents of the hopper can be deposited into a storage compartment e.g., first storage compartment 68) of the vehicle. After releasing the contents of the hopper, the top portion of the hopper can be opened, and the bottom portion of the hopper can be closed to allow refuse to be re-loaded into the hopper for shredding.

### Packing Profile Adjustment for Contaminant Containment

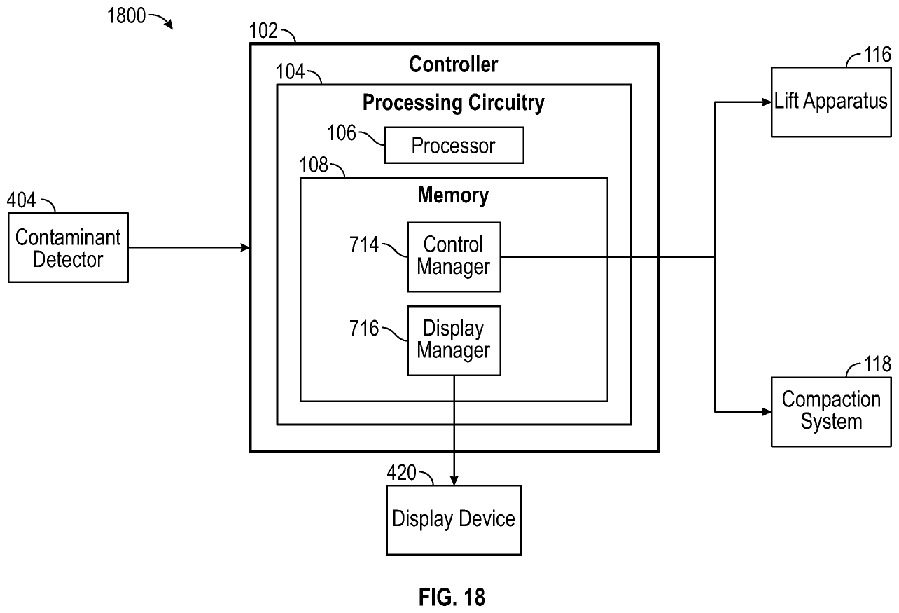

Referring to FIG. 18, depicted is a control system 1800 for adjusting a packing profile of the vehicle 10 to contain contaminants, according to an exemplary embodiment. In some embodiments, the system 1800 includes some/all of the features of the system 500, system 1000, and/or system 1500 such as the controller 102, lift apparatus 116, contaminant detector 404, and the display device 420. The controller is shown to include processing circuitry 104 including one or more processors 106 and memory 108. The memory 108 includes a control manager 714. The control manager 714 can incorporate any of the features of the control manager 414, control manager 514, and/or control manager 614, among other features. The memory 108 is shown to include the display manager 716. The display manager 716 can incorporate any features of the display manager 416, display manager 516, and/or display manager 616, among other features. The system 1000 is shown to include the compaction system, which may compact refuse stored in the refuse vehicle (e.g., to increase an available storage volume within the refuse vehicle).

The controller 102 can operate the lift apparatus 116 to deposit refuse into the vehicle 10. Upon the refuse entering the vehicle 10, the controller can operate or otherwise cause the compaction system 118 to compact the stored refuse, such that the volume of refuse stored in the vehicle 10 is reduced. In some embodiments, contaminant detector(s) 404 may be disposed on the vehicle 10. As refuse enters the vehicle, the contaminant detectors 404 may determine that a contaminant is present. The controller 102 may receive an indication (e.g., signal, notification, alert) from the contaminant detector 404 that an object in the refuse stream is a contaminant. The indication may include a contaminant type, or other information associated with the detected contaminant.

Upon receiving an indication that a contaminant is present in the refuse vehicle 10, the control manager 714 may determine and deploy a desired packing profile for the vehicle 10. The packing profile of the vehicle 10 may include a compaction pressure of the compaction system 118, a target volume for the refuse, or a different metric relating to the compaction of the refuse stored in the vehicle 10. The desired packing profile may be based on the detected contaminant. For example, if a battery is detected, the packing profile may be a reduced compaction to avoid breaking or otherwise damaging the battery. As another example, if a battery is detected, the compaction system 118 may be disabled entirely to avoid damage to the battery.

In some embodiments, the desired packing profile may be deployed for an amount of time corresponding to the amount of time that the contaminant is present in the vehicle 10. For example, if the contaminant is detected at a stop along a multi-stop collection route, the desired packing profile may be deployed for the entire route and/or until the contaminant is removed from the vehicle 10. In some embodiments, the desired packing profile can be selected/overridden by an operator of the vehicle 10. The display manager 516 can display information relating to the packing of refuse/contaminants to the display device 420. For example, the display device 420 may indicate to the user the current packing profile of the vehicle 10. As another example, the display manager 516 may display prompts to the display device 420 requesting operator authorization to implement a packing profile. As yet another example, the display device 420 can include selectable elements allowing an operator to manually override a packing profile once the contaminant is removed.

In some embodiments, the desired packing profile may be deployed for an amount of time corresponding to creating a specific density (e.g., compression, volume, pressure) of refuse around the contaminant, before returning to a normal packing profile. For example, if a battery is detected, the packing profile may be changed to create a lower density around the battery than the density of default packing profile. Once the density of the surrounding area of the contaminant is at the desired density, the packing profile may be returned to the default packing cycle.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A refuse vehicle, comprising:
a body defining a pair of refuse compartments including an isolation compartment and a storage compartment;
a conveyor configured to direct refuse material received into the body into one of the pair of refuse compartments;
an actuator configured to selectively redirect the refuse material from the conveyor to the isolation compartment;
one or more sensors configured to collect sensor data regarding the refuse material; and
processing circuitry configured to:
operate the actuator in a first direction to direct the refuse material to the storage compartment;
determine, based on the sensor data, a presence of an object on the conveyor that should be directed to the isolation compartment; and
operate the actuator in a second direction to redirect the object from the conveyor to the isolation compartment.

2. The refuse vehicle of claim 1, wherein at least one of the pair of refuse compartments comprises at least one of (i) a fire suppressant, (ii) a neutralizing agent, or (iii) an oxygen removal device.

3. The refuse vehicle of claim 1, wherein the processing circuitry is further configured to transmit a notification for display on a display device indicating the object that should be directed to the isolation compartment.

4. The refuse vehicle of claim 1, wherein in response to determining the presence of the object, the processing circuitry is configured to restrict operation of the actuator in the first direction until receiving an user authorization that the object is disposed within the isolation compartment.

5. The refuse vehicle of claim 1, wherein the processing circuitry is configured to:
determine that the object is disposed within the isolation compartment; and
operate the actuator in the first direction to direct the refuse material from the conveyor into the storage compartment.

6. The refuse vehicle of claim 1, comprising a deflector configured to translate between a first position and a second position, wherein in response to determining the presence of the object on the conveyor, the processing circuitry is configured to:
cause the deflector to translate from the first position to the second position;
determine that the object is disposed within the isolation compartment; and
cause the deflector to translate from the second position to the first position.

7. A refuse vehicle, comprising:
a body defining a pair of refuse compartments including a storage compartment and an isolated compartment;
a hopper configured to receive refuse and direct the refuse into one of the pair of refuse compartments;
a robotic arm configured to arrange refuse within the hopper; and
processing circuitry configured to:
receive an indication that an object being deposited into the hopper should be separated from other refuse; and
operate the robotic arm to place the object in a section of the hopper that directs the object for storage in the isolated compartment.

8. The refuse vehicle of claim 7, wherein the robotic arm comprises a shredder configured to shred the refuse, and wherein the processing circuitry is configured to shred the refuse in the section of the hopper.

9. The refuse vehicle of claim 8, further comprising a shredded refuse container configured to store shredded refuse for a predetermined amount of time, wherein the processing circuitry is configured to operate the robotic arm to place the shredded refuse into the section of the hopper after the predetermined amount of time.

10. The refuse vehicle of claim 9, wherein the shredded refuse container comprises a fire suppressant material.

11. The refuse vehicle of claim 7, comprising a lift apparatus configured to deposit refuse into the hopper, wherein the lift apparatus comprises a sensor configured to detect the object in the refuse.

12. The refuse vehicle of claim 7, wherein the robotic arm comprises a sensor configured to detect the object in the refuse, wherein the processing circuitry is configured to:
receive data from the sensor indicating a presence of the object in the refuse; and
cause a notification to be displayed on a display device indicating the presence of the object.

13. The refuse vehicle of claim 7, wherein in response to the robotic arm placing the object in the section of the hopper, the processing circuitry is configured to:
cause a bottom surface of the hopper to move from a closed position to an open position, thereby causing the object to be deposited into the isolated compartment and other refuse to be deposited into the storage compartment.

14. The refuse vehicle of claim 13, wherein in response to the object being deposited into the isolated compartment, the processing circuitry is configured to:
cause the bottom surface of the hopper to move from the open position to the closed position; and
operate a lift apparatus to deposit additional refuse into the hopper.

15. A refuse vehicle, comprising:
a body defining a pair of refuse compartments including a storage compartment and an isolated compartment;
a hopper configured to receive refuse, the hopper comprising a partition separating the hopper into a first hopper portion and a second hopper portion;
an actuator coupled to the partition configured to move the partition between a first position and a second position; and
processing circuitry configured to:
receive an indication that an object being deposited in the hopper should be directed to the isolated compartment; and
operate the actuator to pivot the partition from the first position to the second position responsive to the indication.

16. The refuse vehicle of claim 15, wherein when the partition is in the first position, the first hopper portion is restricted from receiving refuse and when the partition is in the second position, the second hopper portion is restricted from receiving refuse.

17. The refuse vehicle of claim 15, wherein refuse deposited into the first hopper portion is directed to the isolated compartment and refuse deposited into the second hopper portion is directed to the storage compartment.

18. The refuse vehicle of claim 15, wherein the processing circuitry is configured to:
receive an indication that the object has been deposited into the isolated compartment; and
operate the actuator to pivot the partition from the second position to the first position.

19. The refuse vehicle of claim 15, wherein at least one of the pair of refuse compartments comprises at least one of (i) a fire suppressant, (ii) a neutralizing agent, or (iii) an oxygen removal device.

20. The refuse vehicle of claim 15, comprising a lift apparatus configured to deposit the refuse into the hopper and comprising a sensor configured to detect the object in the refuse, wherein the processing circuitry is configured to:
receive sensor data from the sensor regarding the object; and
determine, based on the sensor data, that the object should be directed to the isolated compartment.
